(19) United States
(12) Patent Application Publication
(10) Pub. No.: US 2025/0297522 A1
(43) Pub. Date: Sep. 25, 2025

(54) SYSTEM AND METHOD FOR CONTAINMENT OF WELL FLOWBACK SOLIDS

(71) Applicant: Schlumberger Technology Corporation, Sugar Land, TX (US)

(72) Inventors: Liviu Husoschi, Midland, TX (US); Tom Rasmussen, Esbjerg (DK)

(21) Appl. No.: 18/611,761

(22) Filed: Mar. 21, 2024

(51) Int. Cl. E21B 21/06; B01D 29/68; B01D 29/92

(52) U.S. Cl. CPC E21B 21/066; B01D 29/68; B01D 29/92; B01D 2221/04

(57) ABSTRACT

A filtration system includes a filtration vessel disposed in a first interior of a containment vessel. A wall of the filtration vessel has a porous mesh portion to facilitate migration of a liquid portion of the suspension into a second interior of the filtration vessel. The porous mesh also blocks migration of a solid portion of the suspension into the second interior. The filtration system also includes an extraction system that extracts the liquid portion from the second interior of the filtration vessel.

### BACKGROUND

The present disclosure generally relates to systems and methods for containing suspended solids (e.g., sand) produced during well flowback operations.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

The present invention relates to well flowback operations used after completion of a well drilled for the production of hydrocarbons (e.g., oil). During flowback operations, apart from oil, gas and water, solids (e.g., sand, proppant, solid scale deposits) may be produced by the well. The solids are filtered from the liquids after exiting the well due to the potential for the solids to damage downhole equipment or production surface equipment, and are subsequently stored in a separate container. Once the solids are stored, the solids are known to become difficult to handle and process. As such, improved systems and methods for the containment of solids in well flowback operations is desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

This disclosure relates to a filtration system, comprising: a filtration vessel configured to be disposed in a first interior of a containment vessel, wherein a portion of a wall of the filtration vessel comprises a porous mesh configured to: facilitate migration of a liquid portion of a suspension stored in the containment vessel into a second interior of the filtration vessel; and block migration of a solid portion of the suspension into the second interior; and an extraction system configured to extract the liquid portion from the second interior of the filtration vessel.

In some embodiments, a height of the filtration vessel is greater than a width of the filtration vessel, the filtration vessel is configured to couple to an interior surface of the containment vessel.

In some embodiments, the extraction system comprises: a pump; and a tube fluidly coupled to the pump, wherein an end of the tube is disposed in the second interior of the filtration vessel.

In some embodiments, the system comprises a controller having one or more processors and a sensor configured to provide a signal indicative of a level of the liquid portion inside the filtration vessel surpassing a threshold level.

In some embodiments, the controller is configured to: receive the signal from the sensor; and in response to receiving the signal, instruct the extraction system to extract the liquid portion from the second interior of the filtration vessel.

In some embodiments, the filtration system comprises a cleaning system, the cleaning system comprising: a pump; a tube fluidly coupled to the pump; and a nozzle fluidly coupled to the tube, wherein the nozzle is disposed in the second interior of the filtration vessel.

In some embodiments, the nozzle is configured to disperse a liquid onto the porous mesh to facilitate cleaning of the porous mesh.

In some embodiments, the porous mesh comprises a mesh size ranging from 2 micrometers to 300 micrometers.

The disclosure also relates to an assembly, comprising: a containment vessel configured to receive a suspension from a flowback system; and a filtration system according to any one of the above embodiments.

In some embodiments, the containment vessel comprises: a first inlet formed in a first top portion of a first side wall of the containment vessel; and a diffuser extending from the first inlet through the first interior of the containment vessel, wherein the diffuser comprises a plurality of nozzles configured to disperse the suspension in the first interior.

In some embodiments, the containment vessel comprises a manifold formed in a first bottom portion of the first side wall, a second bottom portion of the second side wall, or a combination thereof, wherein the manifold is configured to receive a first gas configured to facilitate a displacement of a second gas disposed above the suspension in the first interior of the containment vessel.

In some embodiments, the assembly comprises a scale system configured to weigh the solid portion of the suspension disposed within the first interior of the containment vessel, wherein the scale system comprises: a scale having one or more sensors configured to output a signal indicative of a weight, a mass, or a combination thereof; and a user interface configured to receive the signal and display the weight, the mass, or the combination thereof.

In some embodiments, the scale system is distinct from the containment vessel; and a first perimeter of a bottom portion of the containment vessel matches a second perimeter of the scale.

The disclosure also relates to a method, comprising: receiving, via a containment vessel, a suspension from a flowback system, the suspension comprising a liquid portion and a solid portion; separating, via a filtration system, the liquid portion from the solid portion; extracting, via a pump, the liquid portion; and determining, via a sensor, an estimated weight of the containment vessel having the solid portion.

In some embodiments, determining the estimated weight of the containment vessel having the solid portion comprises: positioning the containment vessel on top of a scale system comprising the sensor; and displaying the determined estimated weight on a user interface.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of a flowback system having solid containment system, according to an embodiment of the present disclosure;

FIG. 2 is a schematic view of the solid containment system of FIG. 1, according to an embodiment of the present disclosure;

FIG. 3 is a cross-sectional view of the solid containment system of FIG. 1 having a solid diffuser, according to an embodiment of the present disclosure;

FIG. 4 is a schematic view of the solid containment system of FIG. 1 having a filtration system, according to an embodiment of the present disclosure;

FIG. 5 is a perspective view of the filtration system of FIG. 4, according to an embodiment of the present disclosure; and

FIG. 6 is a flowchart of a process for operating the solid containment system of FIG. 1, according to an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Provided herein is a system and method for the containment of suspended solids (e.g., sand) produced during flowback operations of a hydrocarbon production well. The disclosed embodiments provide for a containment system that includes a containment vessel for the containment and filtering of suspended solids produced from a hydrocarbon well during flowback operations. As disclosed herein, the containment vessel includes a filtration system filter a liquid portion of the suspended solids from a solid portion of the suspended solids. The containment system also includes an extraction system that extracts the liquid portion from the containment vessel. The containment system also includes a scale system that weighs the containment vessel having the solid portion, thereby determining a weight (e.g., based on a mass) of the solid portion of the suspended solids.

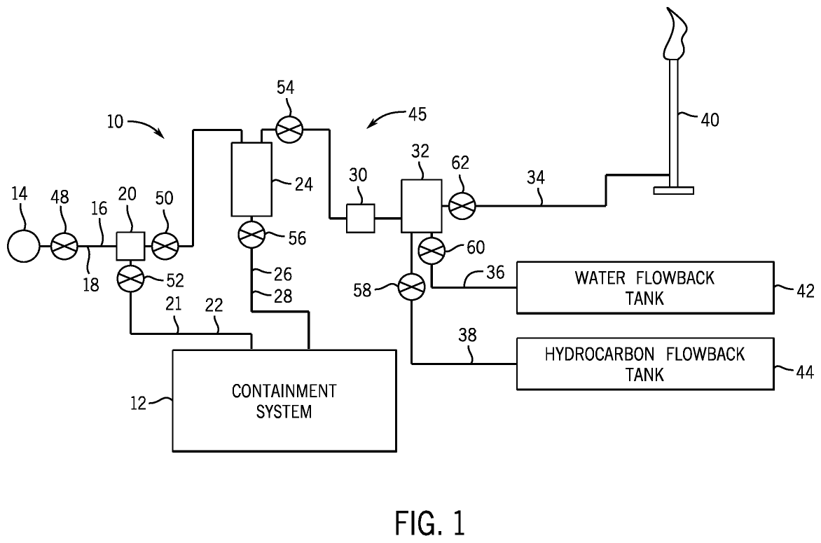

In view of the foregoing, FIG. 1 is a schematic view of a flowback system 10 (e.g., flowback rig, hydrocarbon flowback system) having a containment system 12 (e.g., solid containment system, suspended solids containment system). As shown, the flowback system 10 is fluidly coupled to a well 14 via a line 16, and receives well fluid 18 (e.g., hydrocarbons, water, suspended solids) from the well 14. The flowback system 10 may be used for flowback operations after completion of the well 14 (e.g., after drilling), during which the well 14 is brought to stable production conditions. As shown, after exiting the well 14, the well fluid 18 flows through a plug catcher 20, which diverts solids 21 (e.g., rocks, casing fragments) to the containment system 12 through a solid inlet line 22. A remaining portion of the well fluid 18 flows through a sand separator 24, which separates suspended solids 26 (e.g., sand) from the well fluid 18. The suspended solids 26 are diverted from the sand separator 24 to the containment system 12 through a suspension inlet line 28. The remainder of the well fluid 18 continues to a choke manifold 30. In certain embodiments, the choke manifold 30 may control a pressure of the well fluid 18. After flowing through the choke manifold 30, the well fluid 18 enters a three phase separator 32, which separates the well fluid 18 into gas 34 (e.g., methane, ethane, propane), water 36, and hydrocarbons 38 (e.g., oil). As shown, the gas 34 is diverted to a flaring station 40, the water 36 is diverted to a water flowback tank 42, and the hydrocarbons 38 are diverted to a hydrocarbon flowback tank 44. As shown, the flowback system 10 also includes valves 46 (e.g., valves 48, 50, 52, 54, 56, 58, 60, and 62) that block a flow of the well fluid 18 at various locations throughout the flowback system 10.

In the illustrated embodiment, the containment system 12 is fluidly coupled to both the plug catcher 20 and the sand separator 24. In certain embodiments, the containment system 12 may be fluidly coupled to either the plug catcher 20 or the sand separator 24. In some embodiments, the containment system 12 may be doubly fluidly coupled to the sand separator 24. It may be recognized that the containment system 12 described herein may be incorporated with flowback systems 10 of varying arrangements. Furthermore, in certain embodiments, the flowback system 10 may include more than one containment system 12. For example, the flowback system 10 may include 2, 3, 4, or more containment systems 12.

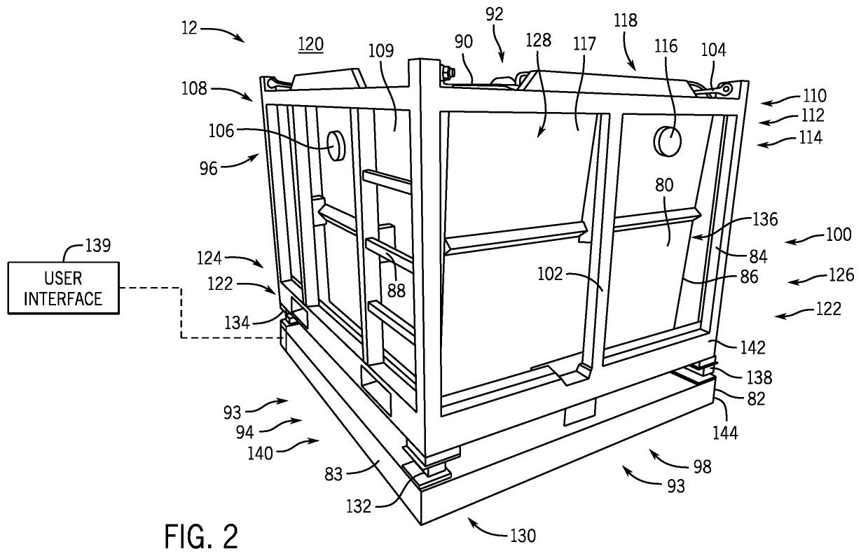

FIG. 2 is a schematic view of the containment system 12 of FIG. 1. As shown, the containment system 12 includes a containment vessel 80 and a scale system 82. In the illustrated embodiment, the containment vessel 80 is shown as having a rectangular prismatic geometry, though it may be recognized that the containment vessel 80 may include a different geometry (e.g., cylindrical, triangular prismatic). The containment vessel 80 is coupled to an exoskeletal structure 84 that has a rectangular prismatic geometry that surrounds (e.g., encloses) an outer perimeter 86 of the containment vessel 80. As shown, the exoskeletal structure 84 includes a ladder 88 to enable an operator to access an opening 90 (e.g., hatch) disposed on a top side 92 of the containment vessel 80. Additionally, the exoskeletal structure 84 includes fork pockets 93 for receiving a fork of forklift for lifting and lowering the containment vessel 80. The fork pockets 93 includes a first pair of fork pockets 94 formed into a first side 96 of the containment system 12, and a second pair of fork pockets 98 formed into a second side 100 of the containment system 12, perpendicular to the first pair of fork pockets 94. It may be appreciated that the perpendicular arrangement of the fork pockets 93 may provide greater access to a forklift used for lifting and lower the containment system 12. The exoskeletal structure 84 also includes one or more vertical braces 102 coupled to the containment vessel 80 to support the containment vessel 80. Additionally, the exoskeletal structure 84 includes protrusions 104 (e.g., handles) that may be used by a crane for transporting the containment system 12.

Additionally, the containment vessel 80 includes a first inlet 106 formed into a first top portion 108 of a first side wall 109 of the containment vessel 80, and a second inlet 110 formed into a third top portion 112 of a third side wall 114 of the containment system 12. The first inlet 106 and/or the second inlet 110 may receive suspended solids (e.g., mud, sand) from the flowback system. In the illustrated embodiment, the first side wall 109 and the third side wall 114 are non-adjacent sides walls that are opposed to one another and possibly parallel to one another. In certain embodiments, the first side wall 109 and the third side wall 114 may be adjacent sides and/or skew relative to one another. In certain embodiments, a first position of the first inlet 106 relative to the second side 100 and the top side 92 may match a second position of the second inlet 110 relative to the second side 100 and the top side 92. In some embodiments, the first position of the first inlet 106 and the second position of the second inlet 110 may not match. That is, in some embodiments, the first inlet 106 may be offset from the second inlet 110. As described in further detail herein, the containment vessel 80 includes a diffuser (e.g., solids diffuser) that extends from the first inlet 106, as discussed in more detail herein.

The containment vessel 80 also includes a filtration opening 116 formed into the containment vessel 80 on the second side wall 117 of the containment vessel 80. As shown, the filtration opening 116 is disposed in a second top portion 118 of the second side wall 117. The filtration opening 116 may receive filtration lines that transfer fluid from an exterior 120 of the containment vessel 80 to an interior of the containment vessel 80, or vice versa. In certain embodiments, the filtration opening 116 may couple to a conduit (e.g., tube) having separate tubes used for the transfer of fluid into and out of the containment vessel 80.

Additionally, the containment vessel 80 includes a manifold 122 formed in a first bottom portion 124 of the first side wall 109, a third bottom portion 126 of the third side wall 114, or a combination thereof. The manifold 122 may receive an inert gas such that the gas migrates to an area 128 above any solids and/or suspended solids stored in the containment vessel 80, such that the inert gas displaces any undesirable gases (e.g., hydrogen sulfide [H₂S], carbon dioxide [CO₂]) produced by the solids and/or the suspended solids. It may be appreciated that the manifold 112 may enable the venting of toxic gases prior to an operator accessing an interior of the containment vessel 80.

In the illustrated embodiment, the containment system 12 also includes the scale system 82. The scale system 82 includes a scale structure 83 (e.g., scale) to weigh the containment vessel 80, the exoskeletal structure 84, and the solids and/or the suspended solids disposed within the containment vessel 80. As shown, the scale system 82 includes sensors 130 (e.g., sensors 132, 134, 136, and 138). The sensors 130 (e.g., load cells) output a signal indicative of a weight, a mass, or a combination thereof. The signal is transmitted to a user interface 139 electrically coupled to the sensors 130. The user interface 139 is receives the signal from a combination of the sensors 130 and the display the weight, the mass, or the combination thereof. It may be appreciated that the scale system 82 described herein may determine an estimated weight of the solids 21 and/or the suspended solids 26 disposed within the containment vessel 80 by accounting for the weight of the containment vessel 80 and the exoskeletal structure 84.

In the illustrated embodiment, the scale structure 83 includes a third pair of fork pockets 140 for receiving a fork of a forklift for transport of the scale structure 83. In certain embodiments, a first outer perimeter 142 (e.g., footprint) of the exoskeletal structure 84 matches a size and shape of a second outer perimeter 144 (e.g., footprint) of the scale structure 83. It may be appreciated that the matching between the first outer perimeter 142 and the second outer perimeter 144 lessens the overall footprint (e.g., space) consumed by the containment system 12.

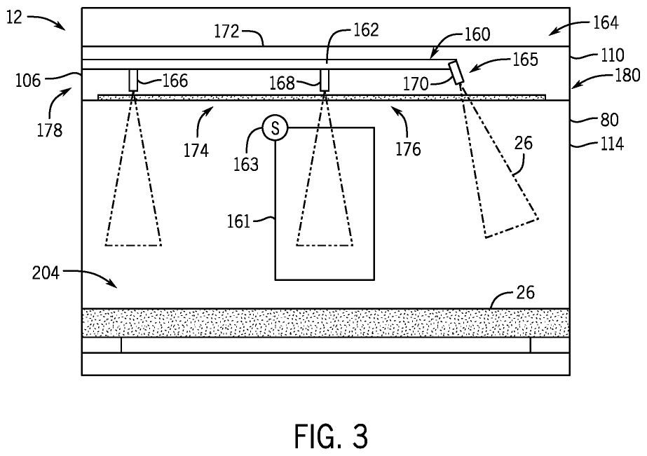

FIG. 3 is a cross-sectional view of the containment system 12 of FIG. 1 having a diffuser 160 for distributing the suspended solid 26 evenly across an interior 204 (e.g., first interior) of the containment vessel 80. In the illustrated embodiment, the diffuser 160 includes a main diffusing conduit 162 that extends across a top portion 164 of the containment vessel 80. For example, the top portion 164 of the containment vessel 80 may be disposed above a filtration vessel 161 and/or a sensor 163 coupled to the filtration vessel, as discussed in further detail herein. In the illustrated embodiment, the main diffusing conduit 162 is coupled to the first inlet 106. In certain embodiments, the main diffusing conduit 162 may be coupled to the second inlet 110 or a combination of the first inlet 106 and the second outlet 110.

As shown, the diffuser 160 includes diffusing nozzles 165 (e.g., nozzles 166, 168, and 170) coupled to the main diffusing conduit 162. The main diffusing conduit 162 along with the diffusing nozzles 165 evenly disperse the suspended solids 26 across the interior 204 of the containment vessel 80 and also decrease a velocity of the suspended solids 26 entering the containment vessel. In certain embodiments, the diffusing nozzles 165 may spray (e.g. spread) the suspended solids 26 radially outward from each of the diffusing nozzles 165. In the illustrated embodiment, the nozzles 166 and 168 are parallel to the third side wall 114 of the containment vessel 80, and the nozzle 170 is angled relative to the third side wall. As shown, the diffusing nozzles 165 includes three nozzles. In certain embodiments, the diffusing nozzles 165 include fewer or more than three nozzles. For example, the diffusing nozzles 165 may include 1, 2, 4, 5, 6, 7, or more nozzles.

In the illustrated embodiment, the diffuser 160 is disposed inside a pipe 172 (e.g., exterior shell) that surrounds the diffuser 160 and extends from the first inlet 106 to the second outlet 110. As shown, the pipe 172 includes a hole 174 formed in a bottom side 176 of the pipe 172. The hole 174 is positioned such that the suspended solids 26 may be dispersed from the diffusing nozzles 165, through the hole 174, and into the interior 204 of the containment vessel 80. In certain embodiments, a first pipe end 178 of the pipe 172 and a second pipe end 180 of the pipe 172 may be interchangeable between the first inlet 106 and the second inlet 110. That is, the pipe 172 may couple to containment vessel 80 such that the first pipe end 178 is coupled to the first inlet 106 and the second pipe end 180 is coupled to the second inlet 110. Additionally or alternatively, the pipe 172 may couple to the containment vessel 80 such that the first pipe end 178 is coupled to the second inlet 110 and the second pipe end 180 is coupled to the first inlet 106.

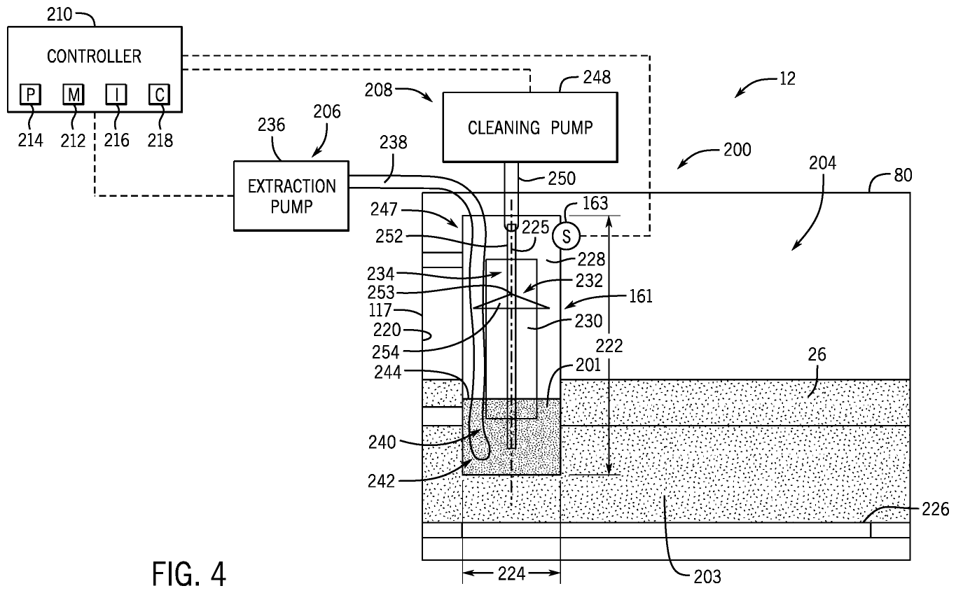

FIG. 4 is a schematic view of the containment system 12 of FIG. 1 having a filtration system 200. As described in further detail herein, the filtration system 200 filters a liquid portion 201 of the suspended solids 26 disposed in the containment vessel 80, leaving behind a solid portion 203 of the suspended solids 26. As shown, the filtration system 200 includes a filtration vessel 161 disposed in an interior 204 of the containment vessel 80. Additionally, the filtration system 200 includes an extraction system 206 that extracts the liquid portion 201 from the filtration vessel 161. The filtration system also includes a cleaning system 208 that cleans the filtration vessel 161. The filtration system 200 also includes a controller 210 having a memory 212 and a processor 214. The processor may execute instructions 216 stored on the memory 212 via communication circuitry 218. As shown, the controller 210 is communicatively coupled with the extraction system 206 and the cleaning system 208.

As shown, the filtration vessel 161 is disposed in the interior 204 of the containment vessel 80 and is coupled to an interior surface 220 of the containment vessel 80. In the illustrated embodiment, a filtration vessel height 222 of the filtration vessel 161 is greater than a filtration vessel width 224 of the filtration vessel 161. As shown, a central axis 225 of the filtration vessel 161 is configured to be substantially vertical and can be substantially parallel with the second side wall 117 of the containment vessel 80; the central axis 225 is also perpendicular to a bottom wall 226 of the containment vessel 80. The filtration vessel 161 may have a cylindrical geometry, a prismatic geometry, or a combination thereof.

In the illustrated embodiment, a filtration wall 228 of the filtration vessel 161 includes a mesh portion 230 (e.g., porous mesh portion) having pores 232. In certain embodiments, the mesh portion 230 may have a mesh size (e.g., size of the pores 232) that ranges from 2 micrometers to 300 micrometers. The mesh portion 230 filters the liquid portion 201 of the suspended solids 26 by facilitating migration of the liquid portion 201 of the suspended solids 26 from the interior 204 of the containment vessel 80, through the mesh portion 230, and into a filtration vessel interior 234 (e.g., second interior). Additionally, the mesh portion 230 blocks migration of the solid portion 203 from the interior 204 of the containment vessel and into the filtration vessel interior 234, thereby separating the liquid portion 201 of the suspended solids 26 from the solid portion 203.

In response to the liquid portion 201 reaching a certain level (e.g., threshold) in the filtration vessel interior 234, the controller 210 may control the extraction system 206 to extract the liquid portion 201 from the filtration vessel interior 234. As shown, the extraction system 206 includes an extraction pump 236 and an extraction line 238 (e.g., tube, conduit) fluidly coupled to the extraction pump 236. In the illustrated embodiment, a distal end portion 240 of the extraction line 238 is disposed at a bottom portion 242 of the filtration vessel interior 234, beneath a top surface 244 of the liquid portion 201. In certain embodiments, the distal end portion 240 of the extraction line 238 may be disposed at another location of the filtration vessel interior 234 beneath the top surface 244.

As shown, the filtration system 200 also includes a sensor 163 (e.g., high liquid level pilot) coupled to a top portion 247 of the filtration vessel 161. The sensor 163 may provide to the controller 210 a signal indicating that the level of the liquid portion 201 inside the filtration vessel 161 has surpassed a threshold level. The controller 210 may receive the signal from the sensor 163 and, in response to receiving the signal, may instruct the extraction system 206 to extract the liquid portion 201 from the filtration vessel interior 234. In certain embodiments, the extraction system 206 may be instructed to extract the liquid portion 201 at set intervals of time (e.g., every hour, every day, every week).

In the illustrated embodiment, the filtration system 200 also includes the cleaning system 208. As shown, the cleaning system 208 includes a cleaning pump 248 and a cleaning line 250 fluidly coupled to the cleaning pump 248. The cleaning system 208 also includes a nozzle 252 having one or more spray ports 253 fluidly coupled to the cleaning line 250. The nozzle 252 is disposed in the filtration vessel interior 234 and disperses a liquid 254 (e.g., water, solvent) onto the mesh portion 230. For example, the nozzle 252 may be spray the liquid 254 from inside the filtration vessel interior 234, such that the sprayed liquid 254 dislodges material that is clogging the mesh portion 230. In certain embodiments, the one or more spray ports 253 may traverse (e.g., slide, telescope) a portion of the filtration vessel height 222, such that the mesh portion 230 is sprayed with a linear motion. In certain embodiments, more than one spray ports 253 may spray the mesh portion 230 simultaneously. In certain embodiments, the controller 210 may instruct the cleaning system 208 to clean the filtration vessel interior 234 at set time intervals (e.g., every half hour, every hour, every day).

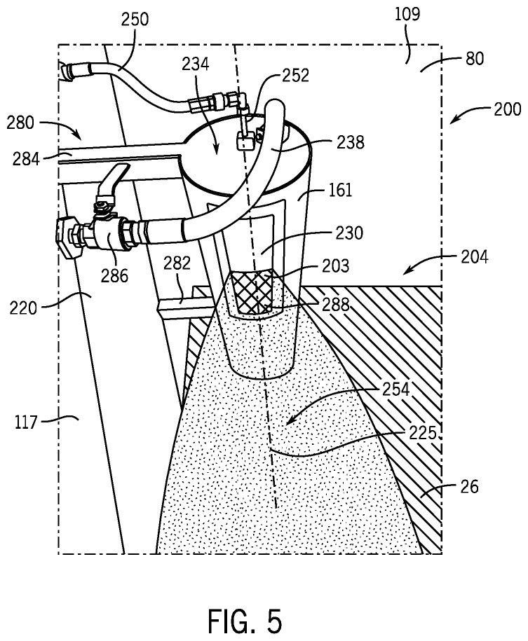

FIG. 5 is a perspective view of a portion of the filtration system 200. As shown, the filtration vessel 161 is disposed in the interior 204 of the containment vessel 80. In the illustrated embodiment, the filtration vessel 161 is coupled to the interior surface 220 of the containment vessel 80 via braces 280 (e.g., low brace 282 and high brace 284). As shown, the extraction line 238 of the extraction system is coupled to the interior surface 220 of the containment vessel 80 via a ball valve 286, and the distal end portion of the extraction line 238 is disposed in the filtration vessel interior 234.

Additionally, the cleaning line 250 of the cleaning system is coupled to the interior surface 220 of the containment vessel 80. As shown, the cleaning line 250 is coupled to the nozzle 252, which is disposed in the filtration vessel interior 234. In the illustrated embodiment, the nozzle 252 is shown as spraying the liquid 254 onto the mesh portion 230. As shown, the nozzle 252 sprays the liquid 254 toward the mesh portion 230 such that the solid portion 203 of the suspended solids 26 is dislodged from an exterior 288 of the mesh portion 230.

In the illustrated embodiment, the filtration vessel 161 has a cylindrical shape and the central axis 225 of the filtration vessel 161 is substantially parallel with the first side wall 109 and the second side wall 117 of the containment vessel 80. In certain embodiments, the filtration vessel 161 may include a prismatic (e.g., rectangular prismatic) shape, and the central axis 225 of the filtration vessel 161 may be skew relative to either the first side wall 109 or the second side wall 117. Although the illustrated embodiment shows one filtration vessel 161 disposed in the interior 204 of the containment vessel 80, the containment vessel 80 may include more than one filtration vessel 161. For example, the containment vessel 80 may include 2, 3, 4, 5, 6, or more filtration vessels 161.

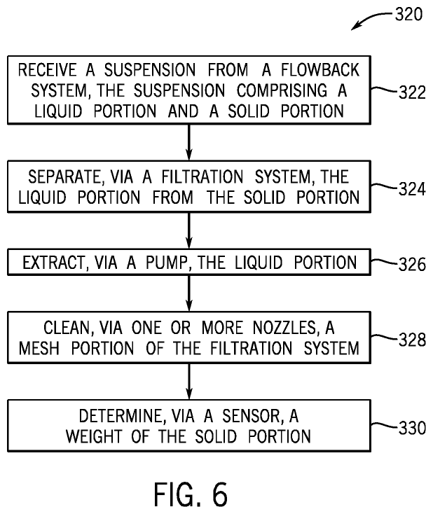

FIG. 6 is a flowchart of a process 320 for operating the containment system. The process 320 may be performed by a computing device or controller disclosed above with reference to FIG. 4 or any other suitable computing device(s) or controller(s). Furthermore, the actions of the process 320 may be performed in the order disclosed herein or in any other suitable order. For example, certain actions of the process 320 may be performed concurrently. In addition, in certain embodiments, at least one of the actions of the process 320 may be omitted.

In block 322 of the process 320, the containment system receives, via a containment vessel, a suspension (e.g., suspended solids) from a flowback system. The suspension includes a liquid portion and a solid portion. For example, the containment vessel may receive the suspension from a plug catcher of the flowback system, a sand separator of the flowback system, or a combination thereof. In certain embodiments, the suspension may include mud (e.g., dirt and water), sand, rocks, casing fragments, or a combination thereof. The containment vessel may receive the suspension via the diffuser, which may distribute the suspension across the interior of the containment vessel.

In block 324 of the process 320, the containment system separates, via a filtration system, the liquid portion of the suspension from the solid portion of the suspension. In certain embodiments, the filtration system includes a filtration vessel having a mesh portion disposed in the containment vessel. The mesh portion of the filtration vessel may block the solid portion of the suspension from entering the filtration vessel as the liquid portion migrates from the interior of the containment vessel, through the apertures of the mesh portion, and into the filtration vessel interior. It may be recognized that the filtration vessel may hold (e.g., store) the liquid portion that passes through the mesh portion such that the liquid portion remains separate from the filtered solid portion disposed exterior to the filtration vessel.

In block 326 of the process 320, the containment system extracts, via a pump, the liquid portion from the interior of the filtration vessel. For example, the containment system may include an extraction system having a pump fluidly coupled to an extraction tube. In certain embodiments, a distal end of the extraction tube may be disposed in the interior of the filtration vessel near a bottom portion of the filtration vessel. The containment system may additionally include a controller that instructs the extraction system. In certain embodiments, the controller may be communicatively coupled to a sensor that may provide the controller with a signal indicative of a level of the liquid portion inside the filtration vessel surpassing a threshold level. Additionally or alternatively, the controller may instruct the extraction system to extract the liquid portion from the interior of the filtration vessel at set time intervals.

In block 328 of the process 320, the containment system cleans, via one or more nozzles, a mesh portion of the filtration system. For example, the containment system may include a cleaning system. The cleaning system may include a cleaning pump fluidly coupled to the one or more nozzles that pumps a liquid (e.g., water) into the one or more nozzles. The one or more nozzles may be disposed in the interior of the filtration vessel of the filtration system. In response to receiving the liquid via the cleaning pump, the one or more nozzles may spray the liquid on a mesh portion of a wall of the filtration vessel, thereby dislodging solid portion stuck on an exterior surface of the mesh portion. In certain embodiments, the one or more nozzles may slide down the interior of the filtration vessel such that the mesh portion is cleaned in a linear motion. In certain embodiments, the one or more nozzles may spray the mesh portion simultaneously. In certain embodiments, the controller may instruct the cleaning system to clean the mesh portion at certain time intervals (e.g., every hour, every day, every week).

In block 330 of the process 320, the containment system determines, via a sensor (e.g., load cell), a weight and/or mass of the solid portion of the suspended solids remaining in the interior of the containment vessel. For example, the containment system may include a scale system that weighs the containment vessel. In certain embodiments, the scale system may include a scale having one or more sensors that output a signal indicative of a weight of the containment vessel when placed on the scale. In certain embodiments, the process 320 includes placing the containment vessel on top of the scale having the one or more sensors. The one or more sensors may send the signal to a controller. The controller may determine an estimated weight of the containment vessel based on the signal. Additionally, the scale system may include a user interface that receives the signal from the controller and/or the one or more sensors and display the estimated weight determined by the controller. In certain embodiments, the controller may account for the weight of the empty containment vessel, thereby reporting an estimated weight indicative of the solid portion of the suspended solids remaining in the containment vessel. In certain embodiments, the process 320 includes displaying the determined estimated weight of the containment vessel on the user interface.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical.

1. A filtration system, comprising:
a filtration vessel configured to be disposed in a first interior of a containment vessel, wherein a portion of a wall of the filtration vessel comprises a porous mesh configured to:
facilitate migration of a liquid portion of a suspension stored in the containment vessel into a second interior of the filtration vessel; and
block migration of a solid portion of the suspension into the second interior; and
an extraction system configured to extract the liquid portion from the second interior of the filtration vessel.

2. The filtration system of claim 1, wherein a height of the filtration vessel is greater than a width of the filtration vessel, the filtration vessel is configured to couple to an interior surface of the containment vessel.

3. The filtration system of claim 1, wherein the extraction system comprises:
a pump; and
a tube fluidly coupled to the pump, wherein an end of the tube is disposed in the second interior of the filtration vessel.

4. The system of any one of claims 1, comprising a controller having one or more processors and a sensor configured to provide a signal indicative of a level of the liquid portion inside the filtration vessel surpassing a threshold level.

5. The system of claim 4, wherein the controller is configured to:
receive the signal from the sensor; and
in response to receiving the signal, instruct the extraction system to extract the liquid portion from the second interior of the filtration vessel.

6. The filtration system of any one of claims 1, comprising a cleaning system, the cleaning system comprising:
a pump;
a tube fluidly coupled to the pump; and
a nozzle fluidly coupled to the tube, wherein the nozzle is disposed in the second interior of the filtration vessel.

7. The filtration system of claim 6, wherein the nozzle is configured to disperse a liquid onto the porous mesh to facilitate cleaning of the porous mesh.

8. The filtration system of claim 1, wherein the porous mesh comprises a mesh size ranging from 2 micrometers to 300 micrometers.

9. An assembly, comprising:
a containment vessel configured to receive a suspension from a flowback system; and
the filtration system of claim 1.

10. The assembly of claim 9, wherein the containment vessel comprises:
a first inlet formed in a first top portion of a first side wall of the containment vessel; and
a diffuser extending from the first inlet through the first interior of the containment vessel,
wherein the diffuser comprises a plurality of nozzles configured to disperse the suspension in the first interior.

11. The assembly of claim 9, wherein the containment vessel comprises a manifold formed in a first bottom portion of the first side wall, a second bottom portion of the second side wall, or a combination thereof, wherein the manifold is configured to receive a first gas configured to facilitate a displacement of a second gas disposed above the suspension in the first interior of the containment vessel.

12. The assembly of claim 9, comprising a scale system configured to weigh the solid portion of the suspension disposed within the first interior of the containment vessel, wherein the scale system comprises:
a scale having one or more sensors configured to output a signal indicative of a weight, a mass, or a combination thereof; and
a user interface configured to receive the signal and display the weight, the mass, or the combination thereof.

13. The assembly of claim 12, wherein the scale system is distinct from the containment vessel; and
wherein a first perimeter of the containment vessel matches a second perimeter of the scale.

14. A method, comprising:
receiving, via a containment vessel, a suspension from a flowback system, the suspension comprising a liquid portion and a solid portion;
separating, via a filtration system, the liquid portion from the solid portion;
extracting, via a pump, the liquid portion; and
determining, via a sensor, an estimated weight of the containment vessel having the solid portion.

15. The method of claim 14, wherein determining the estimated weight of the containment vessel having the solid portion comprises:
positioning the containment vessel on top of a scale system comprising the sensor; and
displaying the determined estimated weight on a user interface.
